(19) United States
(12) Patent Application Publication
(10) Pub. No.: US 2022/0165155 A1
(43) Pub. Date: May 26, 2022

(54) Parking Guidance Method Based on Temporal and Spatial Features and Its Device, Equipment, and Storage Medium

(71) Applicant: SHENZHEN INSTITUTES OF ADVANCED TECHNOLOGY, Shenzhen, Guangdong (CN)

(72) Inventors: Lei PENG, Shenzhen, Guangdong (CN); Yan NIE, Shenzhen, Guangdong (CN)

(21) Appl. No.: 17/440,626

(22) PCT Filed: May 8, 2019
(86) PCT No.: PCT/CN2019/086054

§ 371 Date: Sep. 17, 2021

(51) Int. Cl. G08G 1/14; G08G 1/01; G06N 3/04; G06N 3/08

(52) U.S. Cl. CPC G08G 1/141; G08G 1/147; G06N 3/08; G08G 1/0112; G06N 3/049; G08G 1/0129

(57) ABSTRACT

A parking guidance method based on temporal and spatial features and its device, equipment, and storage medium, wherein the said method consists of two steps: accessing the estimated driving information of the targeted vehicles (S101), where the estimated driving information includes the targeted vehicle's planned driving route, destination and estimated time of arrival; inputting the estimated driving information into the pre-trained city-wide parking guidance system to generate recommended parking lot information for the targeted vehicle, where the city-wide parking guidance system is a spatiotemporal classifier trained with the parking events of urban cities in the current city as the training data (S102). The said method eliminates the necessity of relying on parking data from urban parking lots and effectively improves the city-wide parking guidance effect.

### CROSS-REFERENCE TO RELATED APPLICATION

This application is a national stage application of PCT/CN2019/086054. This application claims priority from PCT Application No. PCT/CN2019/086054, filed May 8, 2019, the content of which is incorporated herein in the entirety by reference.

### TECHNICAL FIELD

The invention falls under the computer technology field, especially involving a parking guidance method based on temporal and spatial features and its device, equipment, and storage medium.

### BACKGROUND TECHNOLOGY

Along with continuous social developments, urban vehicles began to grow faster, but the construction of urban parking lots lagged far behind. Medium and large-sized cities are all faced with a shortage of parking resources, so a lot of time is wasted when the drivers are finding parking places for their cars. Parking Guidance System (PGS) can effectively reduce people's parking time and parking costs in case of insufficient parking resources. However, in the traditional PGS, a message board shall be built on major roads to display the number of unoccupied parking spaces for the surrounding parking lots so as to provide parking guidance for passing cars. As parking becomes increasingly difficult, the traditional PGS can no longer satisfy the rapidly growing parking needs.

In recent years, City-wide Parking Guidance System (CPGS) has been proposed and brought to attention; unlike the traditional PGS, CPGS uses mobile terminals or vehicles as the system terminals to provide parking guidance services for the entire city and eliminate the necessity of deploying message boards on roads. Yet, CPGS relies on parking data of all parking lots in the city for highly accurate parking guidance. To collect the parking data of parking lots, sensors shall be deployed at the parking lots. Due to economic costs and installation and construction time, it is impossible to mount sensors in all urban parking lots. Moreover, parking lots' parking data are often intended for commercial use, and parking lot administrators are basically unwilling to disclose them to third parties. The lack of parking data will greatly affect the guidance results of the parking guidance algorithm.

### SUMMARY OF THE INVENTION

The invention provides a parking guidance method based on temporal and spatial features and its device, equipment, and storage medium, aiming to eliminate the poor city-wide parking guidance because the city-wide parking guidance methods in current technologies heavily rely on parking data of parking lots and these data are not easily accessed.

On the one hand, the invention provides a parking guidance method based on temporal and spatial features, and the said method can be explained in the following steps:

Accessing the estimated driving information of the targeted vehicles, where the said estimated driving information includes the said targeted vehicle's planned driving route, destination, and estimated time of arrival;

Inputting the said estimated driving information into the pre-trained city-wide parking guidance system to generate recommended parking lot information for the said targeted vehicle, where the said city-wide parking guidance system is a spatiotemporal classifier trained with the parking events of urban cities in the current city as the training data.

On the other hand, the invention provides the parking guidance device based on temporal and spatial features, and the said device consists of:

A targeted vehicle information acquisition unit, which is used for accessing the estimated driving information of the targeted vehicles, where the said estimated driving information includes the said targeted vehicle's planned driving route, destination, and estimated time of arrival; and

A parking lot recommendation unit, which is used for inputting the estimated driving information into the pre-trained city-wide parking guidance system to generate recommended parking lot information for the said targeted vehicle, where the said city-wide parking guidance system is a spatiotemporal classifier trained with the parking events of urban cities in the current city as the training data.

On the other hand, the invention also provides a computer device, comprising a memory, a processor, and a computer program stored in the said memory and executable in the said processor, wherein the said steps for the above parking guidance method are effectuated when the said computer program is executed by the said processor.

On the other hand, the invention also provides a computer-readable storage medium in which the computer program is stored, wherein the said steps for the above parking guidance method are effectuated when the said computer program is executed by the said processor.

The invention accesses the estimated driving information of the targeted vehicle, inputs such information into the pre-trained city-wide parking guidance system, and generates recommended parking lot information from the city-wide parking guidance system, thus recommending appropriate parking lots to the targeted vehicles. The parking guidance system is a spatiotemporal classifier trained with the parking events of vehicles in the current city as the training data, which does not rely on the parking data of parking lots, thus avoiding the impact of insufficient parking data from some parking lots and effectively improving the city-wide parking guidance results.

### BRIEF DESCRIPTION OF FIGURES

FIG. 1 presents the flow chart on how the parking guidance method based on temporal and spatial features is effectuated as hereunder provided by Embodiment I of the invention;

FIG. 2 presents the flow chart on how the training of parking guidance system is effectuated by means of the parking guidance method based on temporal and spatial features as hereunder provided by Embodiment II of the invention;

FIG. 3 shows a schematic view of the spatiotemporal classifier in the parking guidance method based on temporal and spatial features as hereunder provided by Embodiment II of the invention;

FIG. 4 shows a schematic view of the parking guidance device based on temporal and spatial features as hereunder provided by Embodiment III of the invention; and

FIG. 5 shows a schematic view of the computer device as hereunder provided by Embodiment IV of the invention.

### A DETAILED DESCRIPTION OF THE INVENTION EMBODIMENTS

In order to present the objects, technical solutions, and advantages of the invention in a more clear way, the invention is further detailed in combination with the appended drawings and embodiments below. It should be understood that specific embodiments described herein just serve the purpose of explaining the invention instead of imposing restrictions on it.

In the following part, specific embodiments are presented for a more detailed description of the invention:

### Embodiment I

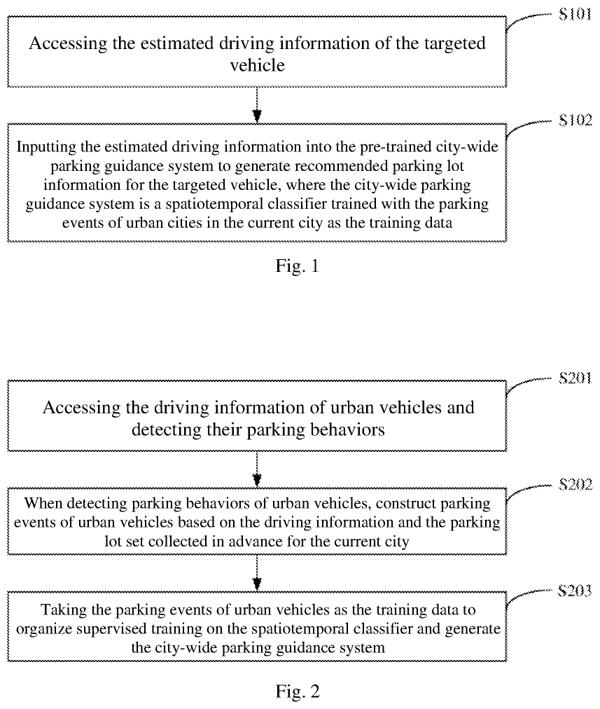

FIG. 1 gives the flow chart on how the parking guidance method based on temporal and spatial features is effectuated as provided by Embodiment I of the invention. For clarification, only some processes regarding this embodiment of the invention are displayed, as detailed below:

In S101, the estimated driving information of the targeted vehicle is accessed.

This embodiment of the invention applies to data processing platforms, systems, or devices, which can be effectuated via the independent computer or a server or server cluster.

In this embodiment of the invention, the estimated driving information of the targeted vehicle is accessed, wherein the estimated driving information includes the targeted vehicle's planned driving route, destination, and estimated time of arrival. The user can directly input the information or receive such information transmitted by the navigation device or system. For instance, the user enters the departure place and destination in the navigation device, and the driving route is then planned by this navigation device or the onboard navigation system based on departure place and destination, thus getting the planned driving route and the estimated time of arrival. Specifically, the planned driving route refers to the planned routes between the departure place and the destination.

In S102, the estimated driving information is inputted into the pre-trained city-wide parking guidance system to generate recommended parking lot information for the targeted vehicle, where the city-wide parking guidance system is a spatiotemporal classifier trained with the parking events of urban cities in the current city as the training data.

In this embodiment of the invention, parking events of urban vehicles include their driving routes, parking time, and parking locations; the preset spatiotemporal classifier is trained with the parking events of urban vehicles in the current city, thus getting the city-wide parking guidance system and eliminating the necessity of relying on parking data of all parking lots (such as the total number of parking spaces, the number of unoccupied parking spaces, etc.). By training the city-wide parking guidance system, the situation that parking data of all urban parking lots are not easily accessed is avoided, and the parking guidance accuracy of the city-wide parking guidance system is effectively improved. Meanwhile, all parking lots in the entire city are effectively covered via many parking events, which helps to effectively enhance the utilization of the city-wide parking guidance system in urban parking lots. Specifically, specific training processes of the spatiotemporal classifier are detailed in Embodiment II, and will not be elaborated here.

In this embodiment of the invention, the city-wide parking guidance system regards each parking lot in the current city as a category to classify the estimated driving information of the targeted vehicle and get the recommended parking lot of the targeted vehicle; then, the recommended parking lot information including geographical location and name is sent back to the targeted vehicle.

In this embodiment of the invention, the city-wide parking guidance system is a spatiotemporal classifier trained with the parking events of urban vehicles in the current city as the training data, wherein the estimated driving information of the targeted vehicle is inputted into the city-wide parking guidance system to get the recommended parking lot information, thus achieving the parking guidance of the targeted vehicle, greatly improving the accuracy and coverage of parking guidance and efficiently optimizing the parking guidance results, without relying on the parking data of urban parking lots.

### Embodiment II

FIG. 2 gives the flow chart on how the training of the city-wide parking guidance system is effectuated via the parking guidance method based on temporal and spatial features as provided by Embodiment II of the invention. For clarification, only some processes regarding this embodiment of the invention are displayed, as detailed below:

In S201, the driving information of urban vehicles is accessed and their parking behaviors are detected.

This embodiment of the invention applies to data processing platforms, systems, or devices, which can be effectuated via the independent computer or a server or server cluster. In this embodiment of the invention, as numerous urban vehicles travel to and fro every day, the proposed parking guidance system can access the driving information of urban vehicles and detect their parking behaviors when they're driving on the road. Specifically, urban vehicles' driving information includes the geographical locations of urban vehicles over time.

Preferably, urban vehicle users mostly rely on navigation systems for navigation. By receiving the navigation information sent by onboard navigation systems, the driving information of urban vehicles can be accessed conveniently and accurately. Further, the line-of-sight propagation of navigation signals decides that these signals will be easily blocked by high-rise buildings. Coupled with system errors from ground launch and signal transmission, the observation errors during the propagation of navigation signals do not strictly follow the Gaussian distribution, so the filtering and prediction accuracy of the Kalman filter cannot be guaranteed. As a nonlinear non-Gaussian filter, the particle filter can be adopted for processing navigation signals, which can reduce the signal drift of navigation signals during the driving process of urban vehicles, and improve the transmission accuracy of navigation signals.

Preferably, by detecting the power supply status of urban vehicles, parking behaviors of urban vehicles are detected in a convenient and accurate manner. Specifically, the motor starts when the power is supplied and stops working when the power is shut off. Further, the navigation system of the urban vehicle is connected to the power source; when the power is shut off, the navigation system also stops working. If it is detected that the transmission of navigation signals is terminated, it means that the urban vehicle is parking, so its parking behavior and parking location can be determined based on the power supply and navigation signals.

In S202, when detecting parking behaviors of urban vehicles, the parking events of urban vehicles will be constructed based on the driving information and the parking lot set collected in advance for the current city.

In this embodiment of the invention, the parking of the urban vehicle is not an object but an event, and the parking events of urban vehicles cannot be directly inputted into the city-wide parking guidance system for training as the image or the text does. Therefore, if the parking of the urban vehicles is detected, the driving routes and current locations of urban vehicles can be acquired from their driving information, and the current location of the urban vehicle is where the vehicle is parked; moreover, the time of detecting the parking is also the parking time. In the parking lot set collected in advance for the current city, the parking lot is queried based on the current locations of urban vehicles, which can be seen as the parking lot where urban vehicles are parked. Specifically, the parking lot set for the current city includes the locations of all parking lots in it.

In this embodiment of the invention, parking events of urban vehicles are composed of parking time, parking locations, and parking lots where they're parked, which are then classified into temporal and spatial data as training data; afterward, these data will be inputted into the city-wide parking guidance system for training of this system. As an example, if the urban vehicle v drives along the road r, arrives at the destination d within the time t, and parks at the parking lot p, then the parking event of the urban vehicle v can be described as:

[wₜ,dₜ,d,r]:p, wherein the time t as the parking time is divided into two parts wₜ and dₜ: wₜ represents the week, and dₜ refers to the specific time in a day. Thus, the spatiotemporal classifier can easily extract temporal features from the parking event of the urban vehicle. In the above equation, the contents on the left of the colon describe the parking process of an urban vehicle from temporal and spatial dimensions, while the contents on the right give the parking result of the urban vehicle as an output of the spatiotemporal classifier.

Preferably, when querying in the parking lot set the parking lot where the urban vehicle is parked, the distances between the parking location of the urban vehicle and different parking lots in the parking lot set are calculated to cluster the parking location to the nearest parking lot for the vehicle, and the clustered parking lot is where the urban vehicle is parked, thus enhancing the accuracy of identifying the parking lot where the urban vehicle is parked.

In S203, by taking the parking events of urban vehicles as the training data, supervised training on the spatiotemporal classifier is organized and the city-wide parking guidance system is generated.

In this embodiment of the invention, parking locations, parking time, and driving routes from the parking events of urban vehicles are inputted into the spatiotemporal classifier, and the parking lots where urban vehicles are parked are set as the target outputs of the spatiotemporal classifier. Thus, supervised training on the spatiotemporal classifier is organized to get a well-trained spatiotemporal classifier. The trained spatiotemporal classifier exactly serves as the trained city-wide parking guidance system.

Preferably, the spatiotemporal classifier consists of Convolutional Neural Network and Long Short-Term Memory (hereinafter referred to as “LSTM”), which makes full use of temporal and spatial features from the parking events of urban vehicles to effectively improve the classification results of the trained spatiotemporal classifier and then greatly enhance the parking guidance results of the city-wide parking guidance system.

More preferably, while organizing the supervised training on the spatiotemporal classifier, parking locations, parking time, and driving routes from the parking events of urban vehicles are inputted into the spatiotemporal classifier. By capturing the spatial features of parking events through the convolutional layer of the spatiotemporal classifier, spatial feature vectors of parking events are obtained. By inputting spatial feature vectors into the LSTM of the spatiotemporal classifier, the temporal features of parking events can be learned by the LSTM to get the temporal feature vectors outputted by it. The outputs of the LSTM are processed by means of the fully connected layer and the activation function in the spatiotemporal classifier to get the recommendation probability of each parking lot in the parking lot set. Based on the recommendation probability of each parking lot in the parking lot set and the parking lots in the parking events of urban vehicles, the training parameters for the spatiotemporal classifier are adjusted, thus organizing supervised training on the spatiotemporal classifier. Specifically, while adjusting the training parameters for the spatiotemporal classifier, the error backpropagation algorithm can be adopted, but the training algorithm for the spatiotemporal classifier is not restricted in this respect.

More preferably, when capturing the spatial features of parking events through the convolutional layer of the spatiotemporal classifier, the convolutional layer can be expressed as:

Cᵢ=f (w*x+b), wherein w is the weight vector of the convolutional layer; b is the bias of the convolutional layer; * refers to the convolutional operation; f ( ) represents the nonlinear activation function. By inputting the parking event into the convolutional layer, the parking event at the moment can be expressed as the vector uₚ, including the parking location, the parking time, and the driving route; after the convolution, the spatial feature vector U′=[u [symbol] ,u [symbol] , . . . , u [symbol] ] of this parking event can be obtained, and n is the number of convolutional kernels in the convolutional layer.

More preferably, when the temporal features of the parking event are being learned by the LSTM, the LSTM consists of the input gate i, the output gate o, the forgotten gate f and the memory cell c; due to the integration of these gates and the memory cell, the data processing capability of the LSTM can be effectively enhanced.

More preferably, the spatial feature vector U′=[u₁′, u₂′, . . . , uₙ′] of the parking event serves as the input for the LSTM; after going through the input gate i, the output gate o, the forgotten gate f, and the memory cell c, the outputted feature of the LSTM is expressed as H=[h₁, h₂, . . . , h_{q}] wherein q is the number of hidden units in the LSTM.

The calculation process of the LSTM can be written as:

$${i}_{t} = σ ( {W}_{xi} {x}_{l} + {W}_{hi} {h}_{h - 1} + {b}_{i} ) , \\ {f}_{t} = σ ( {W}_{xf} {x}_{t} + {W}_{hf} {h}_{h - 1} + {b}_{f} ) , \\ {c}_{t} = {f}_{t} \cdot {c}_{t - 1} + {i}_{t} \cdot {σ}_{h} ( {W}_{xc} {x}_{t} + {W}_{hc} {h}_{h - 1} + {b}_{c} ) , \\ {o}_{t} = σ ( {W}_{xo} {x}_{i} + {W}_{ho} {h}_{h - 1} + {b}_{o} ) .$$

wherein iₜ, oᵣ, fₜ, and cₜ are the tth hidden unit's input gate, output gate, forgotten gate, and memory cell, respectively; Wₓᵢ, Wₓₒ, W_{xf}, and W_{xc} are the weight matrices of input gate, output gate, forgotten gate, and memory cell in the connected convolutional layer and LSTM; Wₓᵢ, Wₓₒ, W_{xf}, and W_{xc} are the weight matrices of input gate, output gate, forgotten gate, and memory cell in the hidden unit of the connected LSTM. bᵢ, bₒ, b_{f} and bₜ are the biases of input gate, output gate, forgotten gate, and memory cell, respectively; σ( ) and σₕ( ) are the activation functions, respectively.

More preferably, in the spatiotemporal classifier, two fully connected layers are connected to the LSTM, and the activation function is utilized in the last fully connected layer to generate the recommendation probability of each parking lot in the parking lot set. Specifically, the first fully connected layer can be expressed as:

H₁=σ′(W₀H+b₀), wherein H is the feature outputted by the LSTM; H₁ is the feature outputted by the first fully connected layer; Wₒ is the weight matrix of the first fully connected layer; bₒ is the bias of the first fully connected layer; σ′( ) is the activation function of the first fully connected layer.

The last fully connected layer can be expressed as:

yₜ=σₛ(W₁H₁+b₁), wherein W₁ is the weight matrix of the last fully connected layer; b₁ is the bias of the last fully connected layer; σₛ( ) is the activation function of the last fully connected layer; yₜ is the output of the last fully connected layer; the dimension of yₜ is consistent with the number of parking lots in the parking lot set; each dimension value refers to the recommendation probability of each parking lot. Preferably, the activation function adopted by the last fully connected layer is Softmax, which is used for the normalization of the recommendation probability of the parking lot so that the outputted recommendation probability is concise and clear.

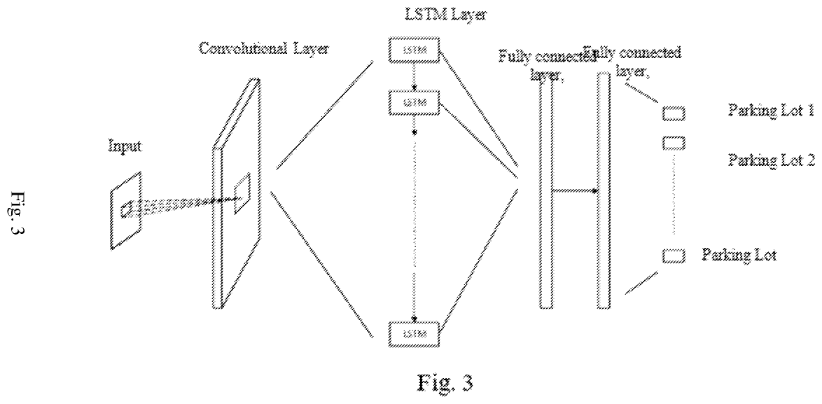

As an example, FIG. 3 presents the schematic view of the spatiotemporal classifier where the classifier consists of the convolutional layer, the Long Short-Term Memory (LSTM) layer, and two fully connected layers; the parking events are inputted into the spatiotemporal classifier to get the recommendation probability of each parking lot corresponding to these parking events.

In this embodiment of the invention, parking events of urban vehicles are collected as the training data for the training of the spatiotemporal classifier composed by the Convolutional Neural Network and the Long Short-Term Memory, which make full use of temporal and spatial features from the parking events, greatly enhance the training results of the spatiotemporal classifier, allow the city-wide parking guidance system to get rid of its dependence on the parking data of parking lots, and effectively improve the parking guidance results of the city-wide parking guidance system.

### Embodiment III

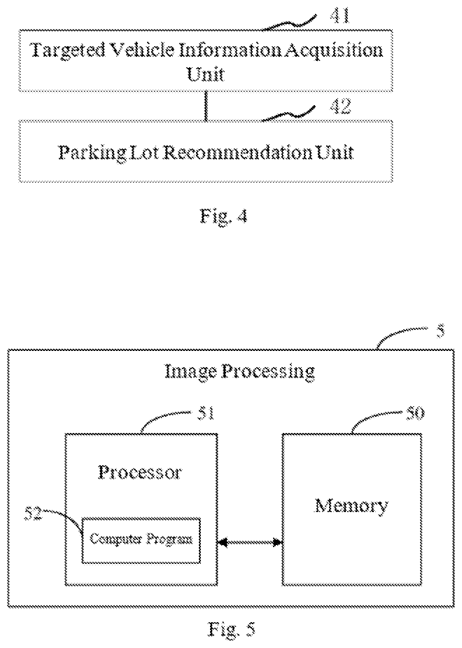

FIG. 4 gives the structure of the parking guidance device based on temporal and spatial features as provided by Embodiment III of the invention. For clarification, only some components regarding this embodiment of the invention are displayed, comprising of:

A targeted vehicle information acquisition unit 41, which is used for accessing the estimated driving information of the targeted vehicles, where the estimated driving information includes the targeted vehicle's planned driving route, destination, and estimated time of arrival; and

A parking lot recommendation unit 42, which is used for inputting the driving information into the pre-trained city-wide parking guidance system to generate recommended parking lot information for the targeted vehicle, where the city-wide parking guidance system is a spatiotemporal classifier trained with the parking events of urban cities in the current city as the training data.

Preferably, the parking guidance device also consists of:

An urban vehicle information acquisition unit, which is used for accessing the driving information of urban vehicles and detecting their parking behaviors;

A parking event construction unit, wherein the parking events of urban vehicles will be constructed based on the driving information and the parking lot set collected in advance for the current city when detecting parking behaviors of urban vehicles; and

A guidance system generation unit, which is used for organizing supervised training on the spatiotemporal classifier and generating the city-wide parking guidance system by taking the parking events of urban vehicles as the training data.

Preferably, the urban vehicle information acquisition unit includes:

A navigation signal receiving unit, which is used for receiving navigation signals transmitted by the navigation systems of urban vehicles; and

A navigation information filter unit, which is used for processing navigation signals with the particle filter to get the driving information.

Preferably, urban vehicles' driving information includes the geographical locations of urban vehicles over time; the parking event construction unit comprises of:

A parking information acquisition unit, which is used for getting parking locations, parking time, and driving routes of urban vehicles from the driving information when detecting parking behaviors of urban vehicles;

A parking lot determination unit, which is used for determining the parking lot where the urban vehicle is parked based on the parking location and the parking lot set; and

A parking event construction subunit, which is used for constructing the parking event of the urban vehicle based on the urban vehicle's parking location, parking time, driving route, and the parking lot where the urban vehicle is parked.

Preferably, the parking lot determination unit consists of:

A parking location clustering unit, which is used for the clustering of parking locations of urban vehicles based on these parking locations and the distances between parking lots in the parking lot set; and

A parking lot determination subunit, which is used for determining the parking lot where the urban vehicle is parked based on the clustering results of parking locations.

Preferably, the guidance system generation unit consists of:

A spatiotemporal classifier training unit, which is used for setting parking locations, parking time, and driving routes from the parking events of urban vehicles as the inputs of the spatiotemporal classifier, and the parking lots in the parking events as the target outputs of the spatiotemporal classifier. Thus, supervised training on the spatiotemporal classifier is organized.

Preferably, the spatiotemporal classifier consists of the Convolutional Neural Network and the Long Short-Term Memory; the guidance system generation unit comprises of:

A spatial feature capturing unit, which is used for capturing spatial features of parking events in the convolutional layer in the spatiotemporal classifier and generating the spatial feature vectors of parking events;

A temporal feature acquisition unit, which is used for inputting spatial feature vectors from parking events into the LSTM of the spatiotemporal classifier, wherein the temporal features of parking events can be extracted by the LSTM; and

A recommendation probability generation unit, which is used for processing the outputs of the LSTM by means of the fully connected layer and the activation function in the spatiotemporal classifier to get the recommendation probability of each parking lot in the parking lot set; and

A parameter adjustment unit, which is used for adjusting the training parameters of the spatiotemporal classifier based on the recommendation probability of each parking lot in the parking lot set and the parking lots in the parking events.

In this embodiment of the invention, the estimated driving information of the targeted vehicle is accessed, and such information is inputted into the pre-trained city-wide parking guidance system to generate recommended parking lot information from the city-wide parking guidance system, thus recommending appropriate parking lots to the targeted vehicles. The parking guidance system is a spatiotemporal classifier trained with the parking events of vehicles in the current city as the training data, which does not rely on the parking data of parking lots, thus avoiding the impact of insufficient parking data from some parking lots and effectively improving the city-wide parking guidance results.

In this embodiment of the invention, how various units of the parking guidance device based on temporal and spatial features are effectuated are detailed in Embodiment I and Embodiment II above, and will not be elaborated again here.

In this embodiment of the invention, various units of the parking guidance device based on temporal and spatial features can be achieved through corresponding hardware or software units, while various units can serve as independent software or hardware units or can be integrated into a software and hardware unit, wherein the invention is not restricted in this respect.

### Embodiment IV

FIG. 5 shows a schematic view of the computer device as provided in Embodiment IV of the invention. For clarification, only some parts regarding this embodiment of the invention are displayed.

In this embodiment of the invention, the computer device 5 consists of a processor 50, a memory 51, and a computer program 52 stored in the memory 51 and executable on the processor 50. When the processor 50 executes the computer program 52, the steps in the embodiments of the above method are effectuated, such as S101 and S102 in FIG. 1, and S201 to S203 in FIG. 2. Alternatively, when processor 50 executes the computer program 52, the functions of various units in the aforementioned device embodiments are effectuated, such as the functions of Unit 41 and Unit 42 in FIG. 4.

In this embodiment of the invention, the estimated driving information of the targeted vehicle is accessed, and such information is inputted into the pre-trained city-wide parking guidance system to generate recommended parking lot information from the city-wide parking guidance system, thus recommending appropriate parking lots to the targeted vehicles. The parking guidance system is a spatiotemporal classifier trained with the parking events of vehicles in the current city as the training data, which does not rely on the parking data of parking lots, thus avoiding the impact of insufficient parking data from some parking lots and effectively improving the city-wide parking guidance results.

### Embodiment V

In this embodiment of the invention, a computer-readable storage medium is presented, provided with a computer program. When the computer program is executed by the processor, the steps in the above method embodiments are effectuated, such as S101 and S102 in FIG. 1, and S201 to S203 in FIG. 2. Alternatively, when the computer program is executed by the processor, the functions of various units in the above device embodiments are effectuated, such as the functions of Unit 41 and Unit 42 in FIG. 4.

In this embodiment of the invention, the estimated driving information of the targeted vehicle is accessed, and such information is inputted into the pre-trained city-wide parking guidance system to generate recommended parking lot information from the city-wide parking guidance system, thus recommending appropriate parking lots to the targeted vehicles. The parking guidance system is a spatiotemporal classifier trained with the parking events of vehicles in the current city as the training data, which does not rely on the parking data of parking lots, thus avoiding the impact of insufficient parking data from some parking lots and effectively improving the city-wide parking guidance results.

In this embodiment of the invention, the computer-readable storage medium comprises any physical device or recording medium, such as ROM/RAM, disc, compact disc, flash memory, and other memories.

The said embodiments just represent the best embodiments of this invention, but do not serve the purpose of restricting this invention; any revision, equivalent replacement, or improvement made within the spirit and principle of this invention is included in the protection scope of this invention.

1. A parking guidance method based on temporal and spatial features, characterized in that the said method comprises of the following steps:
Accessing the estimated driving information of the targeted vehicles, where the said estimated driving information includes the said targeted vehicle's planned driving route, destination, and estimated time of arrival;
Inputting the said estimated driving information into the pre-trained city-wide parking guidance system to generate recommended parking lot information for the said targeted vehicle, where the said city-wide parking guidance system is a spatiotemporal classifier trained with the parking events of urban cities in the current city as the training data.

2. A method as claimed in claim 1, characterized in that the said method also comprises of:
Accessing the driving information of the said urban vehicles and detecting their parking behaviors;
Constructing parking events of the said urban vehicles based on the said driving information and the parking lot set collected in advance for the said current city when detecting parking behaviors of the said urban vehicles;
Taking the parking events of the said urban vehicles as the training data to organize supervised training on the said spatiotemporal classifier and generate the said city-wide parking guidance system.

3. A method as claimed in claim 2, characterized in that the driving information of the said urban vehicles comprises of:
Receiving navigation signals transmitted by the navigation systems of the said urban vehicles;
Processing the said navigation signals with the particle filter to get the said driving information.

4. A method as claimed in claim 2, characterized in that the driving information of the said urban vehicles comprises of geographical locations of the said urban vehicles over time; the steps of constructing the parking events of the said urban vehicles comprise of:
Getting parking locations, parking time, and driving routes of the said urban vehicles from the said driving information when detecting parking behaviors of the said urban vehicles;
Determining the parking lot where the said urban vehicle is parked based on the said parking location and the said parking lot set;
Constructing the parking event of the said urban vehicle based on the said urban vehicle's parking location, parking time, driving route, and the parking lot where the said urban vehicle is parked.

5. A said method as claimed in claim 4, characterized in that the said steps of determining the parking lot where the said urban vehicle is parked comprise of:
Clustering parking locations of the said urban vehicles based on these parking locations and the distances between parking lots in the said parking lot set;
Determining the parking lot where the said urban vehicle is parked based on the clustering results of the said parking locations.

6. A said method as claimed in claim 4, characterized in that the said steps of organizing a supervised training on the preset spatiotemporal classifier comprise of:
Setting parking locations, parking time, and driving routes from the said parking events of urban vehicles as the inputs of the said spatiotemporal classifier, and the parking lots in the said parking events as the target outputs of the said spatiotemporal classifier. Thus, supervised training on the said spatiotemporal classifier is organized.

7. A said method as claimed in claim 2, characterized in that the said spatiotemporal classifier is composed by the Convolutional Neural Network and the Long Short-Term Memory; the steps of organizing a supervised training on the said spatiotemporal classifier comprise of:
Capturing spatial features of the said parking events in the convolutional layer of the said spatiotemporal classifier and generating the spatial feature vectors of the said parking events;
Inputting spatial feature vectors from the said parking events into the LSTM of the said spatiotemporal classifier, wherein the temporal features of the said parking events can be extracted by the LSTM;
Processing the outputs of the said LSTM by means of the fully connected layer and the activation function in the said spatiotemporal classifier to get the recommendation probability of each parking lot in the said parking lot set;
Adjusting the training parameters of the said spatiotemporal classifier based on the recommendation probability of each parking lot in the said parking lot set and the parking lots in the said parking events.

8. A parking guidance device based on temporal and spatial features, characterized in that the said device comprises of:
A targeted vehicle information acquisition unit, which is used for accessing the estimated driving information of the targeted vehicles, where the said estimated driving information includes the said targeted vehicle's planned driving route, destination, and estimated time of arrival; and
A parking lot recommendation unit, which is used for inputting the estimated driving information into the pre-trained city-wide parking guidance system to generate recommended parking lot information for the said targeted vehicle, where the said city-wide parking guidance system is a spatiotemporal classifier trained with the parking events of urban cities in the current city as the training data.

9. A computer device, comprising a memory, a processor, and a computer program stored in the said memory and executed in the said processor, characterized in that the steps as claimed in claim 1 is effectuated when the said computer program is executed by the said processor.

10. A computer-readable storage medium in which the computer program is stored, characterized in that the steps as claimed in claim 1 is effectuated when the said computer program is executed by the said processor.

11. The computer device, comprising a memory, a processor, and a computer program stored in the said memory and executed in the said processor, characterized in that the steps as claimed in claim 9 wherein:
Accessing the estimated driving information of the targeted vehicles, where the said estimated driving information includes the said targeted vehicle's planned driving route, destination, and estimated time of arrival;
Inputting the said estimated driving information into the pre-trained city-wide parking guidance system to generate recommended parking lot information for the said targeted vehicle, where the said city-wide parking guidance system is a spatiotemporal classifier trained with the parking events of urban cities in the current city as the training data.

12. The computer device, comprising a memory, a processor, and a computer program stored in the said memory and executed in the said processor, characterized in that the steps as claimed in claim 9 wherein:
Accessing the driving information of the said urban vehicles and detecting their parking behaviors;
Constructing parking events of the said urban vehicles based on the said driving information and the parking lot set collected in advance for the said current city when detecting parking behaviors of the said urban vehicles;
Taking the parking events of the said urban vehicles as the training data to organize supervised training on the said spatiotemporal classifier and generate the said city-wide parking guidance system.

13. The computer device, comprising a memory, a processor, and a computer program stored in the said memory and executed in the said processor, characterized in that the steps as claimed in claim 9 wherein:
Receiving navigation signals transmitted by the navigation systems of the said urban vehicles;
Processing the said navigation signals with the particle filter to get the said driving information.

14. The computer device, comprising a memory, a processor, and a computer program stored in the said memory and executed in the said processor, characterized in that the steps as claimed in claim 9 wherein:
Getting parking locations, parking time, and driving routes of the said urban vehicles from the said driving information when detecting parking behaviors of the said urban vehicles;
Determining the parking lot where the said urban vehicle is parked based on the said parking location and the said parking lot set;
Constructing the parking event of the said urban vehicle based on the said urban vehicle's parking location, parking time, driving route, and the parking lot where the said urban vehicle is parked.

15. The computer device, comprising a memory, a processor, and a computer program stored in the said memory and executed in the said processor, characterized in that the steps as claimed in claim 9 wherein:
Clustering parking locations of the said urban vehicles based on these parking locations and the distances between parking lots in the said parking lot set;
Determining the parking lot where the said urban vehicle is parked based on the clustering results of the said parking locations.

16. The computer device, comprising a memory, a processor, and a computer program stored in the said memory and executed in the said processor, characterized in that the steps as claimed in claim 9 wherein:
Setting parking locations, parking time, and driving routes from the said parking events of urban vehicles as the inputs of the said spatiotemporal classifier, and the parking lots in the said parking events as the target outputs of the said spatiotemporal classifier. Thus, supervised training on the said spatiotemporal classifier is organized.

17. The computer device, comprising a memory, a processor, and a computer program stored in the said memory and executed in the said processor, characterized in that the steps as claimed in claim 9 wherein:
Capturing spatial features of the said parking events in the convolutional layer of the said spatiotemporal classifier and generating the spatial feature vectors of the said parking events;
Inputting spatial feature vectors from the said parking events into the LSTM of the said spatiotemporal classifier, wherein the temporal features of the said parking events can be extracted by the LSTM;
Processing the outputs of the said LSTM by means of the fully connected layer and the activation function in the said spatiotemporal classifier to get the recommendation probability of each parking lot in the said parking lot set;
Adjusting the training parameters of the said spatiotemporal classifier based on the recommendation probability of each parking lot in the said parking lot set and the parking lots in the said parking events.

18. The computer-readable storage medium in which the computer program is stored, characterized in that the steps as claimed in claim 10 wherein:
Accessing the driving information of the said urban vehicles and detecting their parking behaviors;
Constructing parking events of the said urban vehicles based on the said driving information and the parking lot set collected in advance for the said current city when detecting parking behaviors of the said urban vehicles;
Taking the parking events of the said urban vehicles as the training data to organize supervised training on the said spatiotemporal classifier and generate the said city-wide parking guidance system.

19. The computer-readable storage medium in which the computer program is stored, characterized in that the steps as claimed in claim 10 wherein:
Receiving navigation signals transmitted by the navigation systems of the said urban vehicles;
Processing the said navigation signals with the particle filter to get the said driving information.

20. The computer-readable storage medium in which the computer program is stored, characterized in that the steps as claimed in claim 10 wherein:
Getting parking locations, parking time, and driving routes of the said urban vehicles from the said driving information when detecting parking behaviors of the said urban vehicles;
Determining the parking lot where the said urban vehicle is parked based on the said parking location and the said parking lot set;
Constructing the parking event of the said urban vehicle based on the said urban vehicle's parking location, parking time, driving route, and the parking lot where the said urban vehicle is parked.
